(19) United States
(12) Patent Application Publication
(10) Pub. No.: US 2021/0019297 A1
(43) Pub. Date: Jan. 21, 2021

(54) SERVICE DATA PROCESSING

(71) Applicant: BEIJING SANKUAI ONLINE TECHNOLOGY CO., LTD, Beijing (CN)

(72) Inventor: Xiaojing XIE, Beijing (CN)

(21) Appl. No.: 16/980,823

(22) PCT Filed: Dec. 14, 2018
(86) PCT No.: PCT/CN2018/121119

§ 371 Date: Sep. 14, 2020

(30) Foreign Application Priority Data
Mar. 14, 2018 (CN) 201810209607.9

(51) Int. Cl. G06F 16/22; G06F 16/28; G06F 16/2458; G06Q 20/38; G06Q 20/40; G06F 9/30

(52) U.S. Cl. CPC G06F 16/2246; G06F 16/282; G06F 9/30029; G06Q 20/389; G06Q 20/40; G06F 16/2458

(57) ABSTRACT

Disclosed are a service data processing method including: obtaining a first ordered dictionary tree and a second ordered dictionary tree, converting data of each of leaf nodes of the first ordered dictionary tree and the second ordered dictionary tree into binary data, and performing a comparison operation on the binary data of the leaf nodes at corresponding positions of the first ordered dictionary tree and the second ordered dictionary tree to obtain a difference between the service data of the first object and the second object.

### CROSS-REFERENCE TO RELATED APPLICATIONS

This application is the National Phase of PCT international application PCT/CN2018/121119, entitled “SERVICE DATA PROCESSING” and filed on Dec. 14, 2018,which claims priority to Chinese Patent Application No. 201810209607.9, entitled “SERVICE DATA PROCESSING METHOD AND APPARATUS, ELECTRONIC DEVICE, AND COMPUTER READABLE MEDIUM”, filed on Mar. 14, 2018. Both of the applications are incorporated by reference in their entirety.

### TECHNICAL FIELD

The present disclosure relates to the field of Internet technologies, and in particular, to service data processing in the Internet field.

### BACKGROUND

With the rapid development of Internet technologies, a number of online and offline services are increased dramatically. Due to substantial increase in a frequency of data services, accuracy and real-time requirements for service data processing are increasingly greater.

### SUMMARY

The present disclosure provides a service data processing method, a service data processing apparatus, an electronic device, and a computer readable medium.

Other features and advantages of the present disclosure are apparent through the following detailed description, or partly learned through practice of the present disclosure.

According to an aspect of the present disclosure, a service data processing method is provided, including: obtaining a first ordered dictionary tree and a second ordered dictionary tree, where the first ordered dictionary tree is created according to a hierarchical relationship of service data of a first object, and the second ordered dictionary tree is created according to a hierarchical relationship of service data of a second object; converting data of each of leaf nodes of the first ordered dictionary tree and the second ordered dictionary tree into binary data; and performing a comparison operation on the binary data of the leaf nodes at the corresponding positions of the first ordered dictionary tree and the second ordered dictionary tree to obtain a difference between the service data of the first object and the second object.

According to an aspect of the present disclosure, an electronic device is provided, including a storage medium, a processor, and machine executable instruction stored on the storage medium and executable on the processor, the machine executable instruction implementing steps of the method according to the foregoing aspect when being executed by the processor.

According to an aspect of the present disclosure, a non-transient computer-readable storage medium is provided, a computer program being stored thereon, where when the program is executed by a processor, steps of the method according to the foregoing aspect are implemented.

It can be understood that the above general descriptions and the following detailed descriptions are merely exemplary, and cannot limit the present disclosure.

### BRIEF DESCRIPTION OF THE DRAWINGS

The above and other objectives, features, and advantages of the present disclosure will become more apparent from the detailed description of exemplary embodiments of the present disclosure with reference to the accompanying drawings.

FIG. 1 is a flowchart of a service data processing method according to according to some embodiments of the present disclosure.

FIG. 2 is a flowchart of a service data difference determining method according to some embodiments of the present disclosure.

FIG. 3 is a schematic structural diagram of an ordered dictionary tree according to some embodiments of the present disclosure.

FIG. 4 is a schematic diagram of a service data processing apparatus according to some embodiments of the present disclosure.

FIG. 5 is a schematic diagram of an electronic device according to some embodiments of the present disclosure.

### DETAILED DESCRIPTION

The examples of embodiments are described comprehensively with reference to the accompanying drawings. The examples of embodiments are described comprehensively with reference to the accompanying drawings. Conversely, the embodiments are provided to make the present disclosure more comprehensive and complete, and comprehensively convey the idea of the examples of the embodiments to a person skilled in the art. The accompanying drawings are merely exemplary illustrations of the present disclosure and are not necessarily drawn to scale. The same reference numbers in the drawings represent the same or similar parts, and therefore, repeated descriptions thereof are omitted.

In addition, the described features, structures, or characteristics may be combined in one or more embodiments in any appropriate manner. In the following descriptions, a lot of details are provided to give a comprehensive understanding of the embodiments of the present disclosure. However, a person skilled in the art should be aware that, the technical solutions in the present disclosure may be implemented without one or more of the particular details, or another method, component, apparatus, or step may be used. In other cases, known structures, methods, apparatuses, embodiments, or operations are not shown or described in detail to avoid obscuring aspects of the present disclosure.

With the rapid development of Internet technologies, a number of online and offline services are increased dramatically. Due to substantial increase in a frequency of data services, accuracy and real-time requirements for service data processing are increasingly greater. An account checking method adopted for an existing online account checking platform generally includes: merging files; sequencing the files; and taking the files out row by row for check. Due to low efficiency of such account checking method, the method is improved to some extent by using existing technologies. Improvements include: cutting a file first, mapping a sub-file obtained by cutting to a key, and taking a value according to the key.

Although such account checking method improves work efficiency to some extent, it takes an extremely long time for mapping, so that an overall time of the account checking method is longer, and the real-time requirements for account checking by a transaction platform are not met.

FIG. 1 is a flowchart of a service data processing method according to some embodiments. As shown in FIG. 1, the service data processing method may include the following steps.

In step S101, a first ordered dictionary tree and a second ordered dictionary tree are obtained, the first ordered dictionary tree being created according to a hierarchical relationship of service data of a first object, and a second ordered dictionary tree being created according to a hierarchical relationship of service data of a second object.

In some embodiments, the first object and the second object may be different users who need to perform service data comparison. For example, the first object and the second object may be respectively a bank and a merchant that need to perform account checking, or a customer and a customer who need to perform account checking, or different departments or users that need to perform data consistency verification. The service data may be account checking data or data used for verification, and the present disclosure does not specifically limit types of the first object, the second object, and the service data.

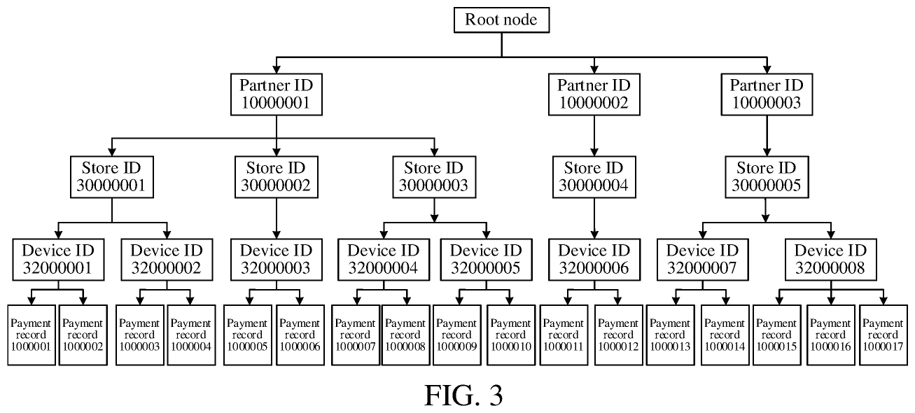

In this embodiment, referring to FIG. 3, during creation of an ordered dictionary tree according to a hierarchical relationship of service data, data of each layer of the first ordered dictionary tree and the second ordered dictionary tree may be arranged according to a certain rule, for example, being arranged in ascending order from left to right. Definitely, in other exemplary embodiments of the present disclosure, the data of each layer of the foregoing ordered dictionary tree may further be arranged in descending order from left to right.

The foregoing ordered dictionary tree may further be referred to as a prefix tree, a dictionary tree, or a word search tree. As an ordered tree, a key of each node of the ordered dictionary tree is not directly stored in the node, but is determined by a position of the node in the tree. Keys of all descendant nodes of one node have a same prefix, that is, a string representing the key corresponding to this node, and a key corresponding to a root node may be a predetermined string such as an empty string. In general, not all keys corresponding to nodes have values, but only the keys corresponding to leaf nodes and some internal nodes have relevant values.

For example, referring to FIG. 3, the foregoing first object is a merchant who needs to perform account checking, and a hierarchical relationship of service data thereof includes: one or more partners. One partner may include one or more stores, one store may be provided with one or more devices for collecting payments, and each device may have one or more corresponding payment records. An ordered dictionary tree may be established according to a hierarchical relationship between partners, stores, devices, and payment records shown in FIG. 3, and the payment records may be used as leaf nodes.

The payment records may include, but are not limited to, information such as a payment record identifier, a transaction amount, a transaction status, and a day switch time. The transaction status may include, but is not limited to, a transaction success, a transaction refund, etc. Different transaction statuses may be represented by different status codes. For example, a status code for the transaction success is 8, and a status code for the transaction refund is 10, etc. The day switch time refers to a time for which system accounting is changed. The system switches from a current working day to a next working day, and a transaction during day switch may be submitted as usual to be processed correctly and returned. For example, day switch is performed at 12 at noon every day, an actual transaction time of a certain transaction is 12:20:40 on Jan. 18, 2018, and then a day switch time is Jan. 18, 2018.

In addition, the leaf node may further include data of a corresponding intermediate hierarchical node, such as the partner identifier, the store identifier, and the device identifier. In this way, each of the leaf nodes may include complete information required for data consistency verification.

As shown in FIG. 3, the foregoing identifiers may be in a form of an identity code (ID). The partner IDs, store IDs, device IDs, and payment record IDs shown in FIG. 3 are only illustrative examples, and are not a limitation on a number of the partners, stores, devices, and payment records.

In step S102, data of each of leaf nodes of the first ordered dictionary tree and the second ordered dictionary tree is converted into binary data.

In some embodiments, in a database, each item of data in the ordered dictionary tree may be stored in decimal form. After the ordered dictionary tree is generated according to a hierarchical relationship of service data of an object, information included in each of leaf nodes of the ordered dictionary tree may be converted into binary data by using a bitmap algorithm. For example, information such as the partner IDs, store IDs, device IDs, payment record IDs, transaction amount, day switch time, and transaction status included in each of the leaf nodes may be converted, through the bitmap algorithm, into a binary form for storage. The bitmap algorithm uses at least one bit to mark a value corresponding to a key, and the key is this element. By using the bit as a unit for storing data, a relatively large storage space may be saved.

For example, referring to Table 1 below, information about a leaf node in an ordered dictionary tree is represented in a binary form. A partner ID, a store ID, a device ID, and a payment record ID are represented by a 16-bit binary number, a transaction amount is represented by a 24-bit binary number, a day switch time is represented by a 32-bit binary number, and a transaction status is represented by a 4-bit binary number. An actual storage value of the leaf node is:

1010101010010001101010101001000110101010100100011010101010010001101010 101001000110101010101010101001000110101010100100011010.

TABLE 1

| | |
|---|---|
| Partner ID | 1010101010010001 |
| Store ID | 1010101010010001 |
| Device ID | 1010101010010001 |
| Payment record ID | 1010101010010001 |
| Transaction amount | 101010101001000110101010 |
| Day switch time | 10101010100100011010101010010001 |
| Transaction status | 1010 |

In step S103, a comparison operation is performed on binary data of the leaf nodes at corresponding positions of the first ordered dictionary tree and the second ordered dictionary tree to obtain a difference between the service data of the first object and the second object. The comparison operation is performed respectively on two leaf nodes located at corresponding positions of the first ordered dictionary tree and the second ordered dictionary tree. For example, the corresponding position may refer to a specific location at a same hierarchy, such as a leaf node representing a payment record.

In some embodiments, the foregoing step S103 may include the following.

Step S1031: Perform an exclusive OR operation on the binary data of the leaf nodes at the corresponding positions of the first ordered dictionary tree and the second ordered dictionary tree to obtain a comparison result.

Step S1032: Determine, in response to that the comparison result is not zero, that there is a difference between the service data of the first object and the second object at the corresponding positions.

For example, after each of the leaf nodes of the ordered dictionary tree of the service data of the first object and the second object is converted into a binary number, the leaf nodes at the corresponding positions may be compared to determine whether there is a difference between two sets of service data. For example, the comparison method may be performed by using an exclusive OR operation, and an exclusive OR logic may be expressed as follows:
in response to that A and B are different, output P=1; and
   in response to that A and B are the same, output P =0.

Therefore, if a result obtained after the exclusive OR operation on the two sets of data is zero, it indicates that the two sets of data are exactly the same; and if the result obtained after the exclusive OR operation on the two sets of data is not zero, it indicates that there is a difference between the two sets of data.

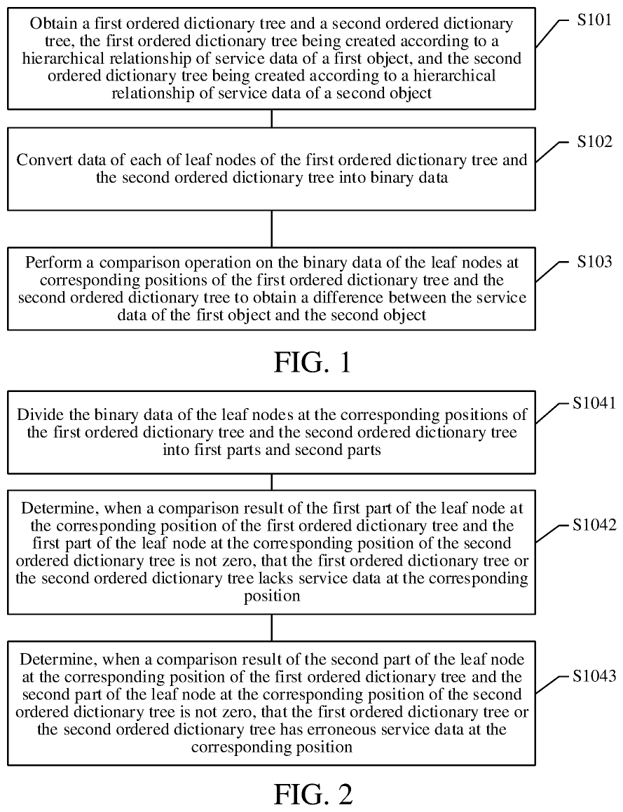

Based on the foregoing, in some embodiments, referring to FIG. 2, when the result obtained after the exclusive OR operation is not zero, that is, when it is determined that there is a difference between the two sets of data, the foregoing method may further include the following.

Step S1041: Divide the binary data of the leaf nodes at the corresponding positions of the first ordered dictionary tree and the second ordered dictionary tree into first parts and second parts.

Step S1042: Determine, in response to that a comparison result of a first part of the leaf node at the corresponding position of the first ordered dictionary tree and a first part of the leaf node at the corresponding position of the second ordered dictionary tree is not zero, that the first ordered dictionary tree or the second ordered dictionary tree lacks service data at the corresponding position.

Step S1043: Determine, in response to that a comparison result of a second part of the leaf node at the corresponding position of the first ordered dictionary tree and a second part of the leaf node at the corresponding position of the second ordered dictionary tree is not zero, that the first ordered dictionary tree or the second ordered dictionary tree has erroneous service data at the corresponding position.

By dividing the data of the leaf nodes, a reason for data difference may be analyzed, such as lack of data or a data error. For example, one or more of the partner ID, store ID, device ID, and transaction record ID included in the foregoing leaf node may be used as a first part, and one unique record may be determined based on the first part. The transaction amount, transaction status, and day switch time are then used as a second part, and it is determined whether there is a difference in data of the unique record by using the unique record.

For example, during account checking, the first parts of the leaf nodes may be compared first. Because the leaf nodes in the ordered dictionary tree are ordered from left to right, if a value corresponding to a first part of the leaf node at a corresponding position of the first ordered dictionary tree is smaller than a value corresponding to a first part of the leaf node at a corresponding position of the second ordered dictionary tree, it indicates that the second ordered dictionary tree lacks service data at the corresponding position, that is, the first ordered dictionary tree is unilateral. If the value corresponding to the first part of the leaf node at the corresponding position of the first ordered dictionary tree is greater than the value corresponding to the first part of the leaf node at the corresponding position of the second ordered dictionary tree, it indicates that the first ordered dictionary tree lacks service data at the corresponding position, that is, the second ordered dictionary tree is unilateral. For example, the service data at the corresponding position that the first ordered dictionary tree or the second ordered dictionary tree lacks includes, but is not limited to a device ID or a transaction record ID.

After comparison of the first parts of the leaf nodes at the corresponding positions is completed, second parts may be compared. If there is a difference between the second parts of the leaf nodes at the corresponding positions, it indicates that the leaf nodes have erroneous service data at the corresponding positions. For example, it may be that one or more of the transaction amounts in the first ordered dictionary tree or the second ordered dictionary tree, transaction statuses, or the day switch time may be inconsistent. That is to say, data in which there may be errors includes, but is not limited to, one or more of transaction amounts, transaction statuses, and the day switch time

For example, when an e-commerce platform and a bank separately generate statements of account for checking, assuming that there are 10,000 payment records in the bank, and the e-commerce platform lacks a 4988th payment record, during first comparison of the 4988th payment record of the bank, the payment record of the bank is actually compared to the 4989th payment record of the e-commerce platform. Because the dictionary trees are ordered, during comparison of the first parts of the leaf nodes, a first part of the 4989th payment record data of the e-commerce platform is greater than a first part of the 4988th payment record data of the bank, and it indicates that the e-commerce platform lacks a payment record. At this time, the bank may take a piece of service data backward and continue to compare the piece of service data to the service data of the e-commerce platform. In other words, the 4989th payment record of the bank is compared to the 4989th payment record of the e-commerce platform.

In other exemplary embodiments of the present disclosure, the foregoing method may further include: binary data of the corresponding leaf nodes of the first ordered dictionary tree and the second ordered dictionary tree may be segmented in a distributed manner, so that a performing speed during comparison is increased.

For example, data of a same size may be intercepted from the first object and the second object that need to be verified for data consistency, and verification operation may be started. If there is an inconsistency in the numbers of data items, due to orderly nature of the ordered dictionary trees, a corresponding amount of data may be obtained in order on a side having less data and account checking may be started. In some embodiments, time complexity of taking data may be O(1) or other values.

In addition, during account checking, the service data of the first object and the second object may be further segmented separately, and different pieces of segmented data may be compared on different devices at the same time, that is, a comparison operation is performed in a distributed manner, so that efficiency of data comparison may be improved efficiently and a time consumed for data comparison may be shortened greatly.

In addition, in other exemplary embodiments of the present disclosure, it is further possible to collect a time for loading of service data and time for the comparison operation, etc., to obtain an impact of the amount of service data on the overall time, so as to obtain a reasonable data volume interval for the service data processing method.

In some embodiments, the foregoing service data processing method may further include the following.

Step S1051: Collect a difference between the service data of the first object and the second object.

Step S1052: Classify the difference between the service data of the first object and the second object according to a collection result to generate a fishbone diagram.

After the difference between the service data of the first object and the second object is obtained, a fishbone diagram may be generated based on the difference. The data difference is classified by using the fishbone diagram and a reason for the data difference may be analyzed. For example, according to the fishbone diagram, it may be determined that the reason for the data difference is in a store, a device, or the network, etc.

For example, assuming that there is a network failure on the e-commerce platform, if a bank receives a payment from a customer and generates a corresponding payment record, but the e-commerce platform fails to synchronize the payment record due to a network reason, the e-commerce platform lacks the payment record at this time. Alternatively, if the bank receives the payment from the customer and generates the corresponding payment record, but the e-commerce platform only performs reversal on the payment the next day, the e-commerce platform and the bank have inconsistent transaction statuses for this payment record. At this time, lack of a payment record or payment records that have inconsistent transaction statuses may be classified through the fishbone diagram and a reason therefor is further analyzed. In addition, if a device often has a payment success in the bank but is in a reversal status in the e-commerce platform, a reason therefor may be analyzed by using the fishbone diagram, and it may be determined, according to a reversal ratio, whether the device has a device failure.

The service data processing method provided by this embodiment of the present disclosure may be applied to users who need to perform data consistency verification in different fields such as an online account checking platform and a small merchant. On the one hand, through conversion of data of each of the leaf nodes of the ordered dictionary tree into binary data by using a bitmap algorithm, a relatively large storage space may be saved, and subsequent difference processing may be facilitated. On the other hand, through calculation, by using an exclusive OR operation of the bitmap algorithm, whether there is a difference between the service data of the two objects, the difference between the service data may be determined and positioned accurately and quickly. Through conversion of the service data into an ordered dictionary tree, and then the data of each of the leaf nodes in the ordered dictionary tree is converted into binary data, for comparison, by using the bitmap algorithm, a speed at which data comparison is performed may be effectively improved. In addition, through classification of differences between the service data for generation of the fishbone diagram, the user may quickly and accurately analyze the reason for the data difference.

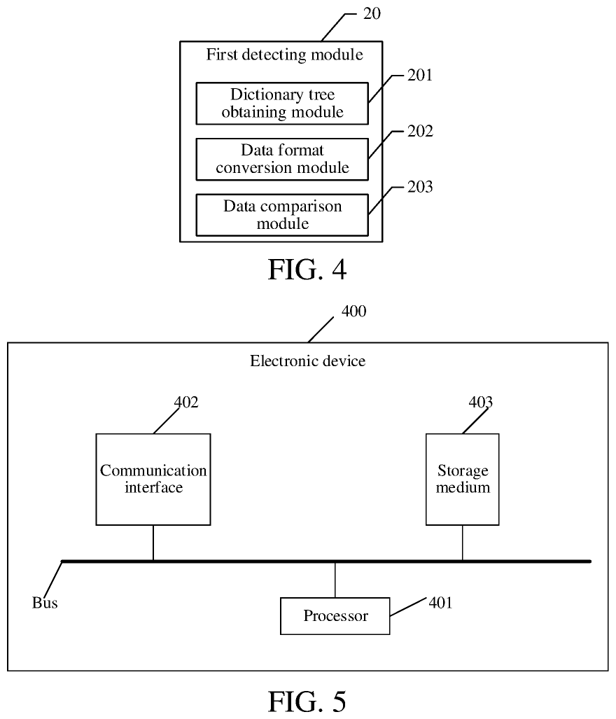

FIG. 4 is a block diagram of a service data processing apparatus according to some embodiments. As shown in FIG. 4, a first detecting module 20 may include a dictionary tree obtaining module 201, a data format conversion module 202, and a data comparison module 203.

The dictionary tree obtaining module 201 may be configured to obtain a first ordered dictionary tree and a second ordered dictionary tree. The first ordered dictionary tree is created according to a hierarchical relationship of service data of a first object, and the second ordered dictionary tree is created according to a hierarchical relationship of service data of a second object.

The data format conversion module 202 may be configured to convert data of each of leaf nodes of the first ordered dictionary tree and the second ordered dictionary tree into binary data.

The data comparison module 203 may be configured to perform a comparison operation on the binary data of the leaf nodes at corresponding positions of the first ordered dictionary tree and the second ordered dictionary tree to obtain a difference between the service data of the first object and the second object.

It should be noted that, for implementation of the functional modules of the service data processing apparatus provided in the foregoing embodiment, reference may be made to the above contents of the service data processing method shown in FIG. 1, and details are not described herein again.

According to some other embodiments of the present disclosure, an electronic device is further provided. The electronic device may include a storage medium, a processor, and machine-executable instructions stored in the storage medium and executable on the processor. When the machine-executable instructions are executed by the processor, steps of the following steps of the method are implemented:

obtaining a first ordered dictionary tree and a second ordered dictionary tree, where the first ordered dictionary tree is created according to a hierarchical relationship of service data of a first object, and the second ordered dictionary tree is created according to a hierarchical relationship of service data of a second object; converting data of each of leaf nodes of the first ordered dictionary tree and the second ordered dictionary tree into binary data; and performing a comparison operation on the binary data of the leaf nodes at corresponding positions of the first ordered dictionary tree and the second ordered dictionary tree to obtain a difference between the service data of the first object and the second object.

In some embodiments, when the machine-executable instructions are executed by the processor, the following steps of the method are implemented: performing an exclusive OR operation on the binary data of the leaf nodes at corresponding positions of the first ordered dictionary tree and the second ordered dictionary tree to obtain a comparison result; and determining, in response to that the comparison result is not zero, that there is a difference between the service data of the first object and the second object at the corresponding positions.

In some embodiments, when the machine-executable instructions are executed by the processor, the following steps of the method are implemented: dividing the binary data of the leaf nodes at the corresponding positions of the first ordered dictionary tree and the second ordered dictionary tree into first parts and second parts; determining, in response to that a comparison result of a first part of the leaf node at the corresponding position of the first ordered dictionary tree and a first part of the leaf node at the corresponding position of the second ordered dictionary tree is not zero, that the first ordered dictionary tree or the second ordered dictionary tree lacks service data at the corresponding position; and determining, when a comparison result of a second part of the leaf node at the corresponding position of the first ordered dictionary tree and a second part of the leaf node at the corresponding position of the second ordered dictionary tree is not zero, that the first ordered dictionary tree or the second ordered dictionary tree has an error in service data at the corresponding position.

In some embodiments, each of the leaf nodes of the first ordered dictionary tree and the second ordered dictionary tree includes binary data of a partner identifier, a store identifier, a device identifier, a transaction record identifier, an amount, a day switch time, and a transaction status.

In some embodiments, a first part of the leaf node includes binary data of the partner identifier, the store identifier, the device identifier, and the transaction record identifier, and a second part of the leaf node includes binary data of the amount, the day switch time, and the transaction status.

In some embodiments, the data of the first ordered dictionary tree and the second ordered dictionary tree are arranged in ascending order of size from left to right.

In some embodiments, each of the leaf nodes of the first ordered dictionary tree and the second ordered dictionary tree includes data of a corresponding intermediate node.

In some embodiments, when the machine-executable instructions are executed by the processor, the following comparison operation is implemented: segmenting the binary data of the leaf nodes at the corresponding positions of the first ordered dictionary tree and the second ordered dictionary tree; and performing, in a distributed manner, comparison on the data obtained through the segmentation.

In some embodiments, when the machine-executable instructions are executed by the processor, the following steps of the method are further implemented: collecting differences between the service data of the first obj ect and the second obj ect; and classifying the differences between the service data of the first object and the second object according to a collection result to generate a fishbone diagram.

FIG. 5 is a schematic structural diagram of an electronic device 400 adapted to implement the embodiments of this application. The electronic device shown in FIG. 5 is merely an example, and should not impose any limitation on a function and use scope of the embodiments of this application.

As shown in FIG. 5, the electronic device 400 includes a processor 401 that can perform various proper actions and processing according to a program stored in a storage medium 403. In particular, according to the embodiments of the present disclosure, the processes described above with reference to the flowchart may be implemented as a computer software program. For example, embodiments of the present disclosure include a computer program product, including a computer program carried on a computer-readable medium. The computer program includes program code for performing the method shown in the flowchart. When the computer program is executed by the processor 401, the above functions defined in the system of this application are performed. The processor 401, the storage medium 403, and a communication interface 402 are connected to each other through a bus.

Flowcharts and block diagrams in the accompanying drawings illustrate architectures, functions, and operations that may be implemented by using a terminal, a server, a method, and a computer program product according to the various embodiments of this application. In this regard, each block in the flowchart or the block diagram may represent a module, a program segment, or a part of code. The module, the program segment, or the part of the code includes one or more executable instructions for implementing a specified logical function. It should also be noted that, in some embodiments used as substitutes, functions annotated in boxes may alternatively be occur in a sequence different from that annotated in an accompanying drawing. For example, actually two boxes shown in succession may be performed basically in parallel, and sometimes the two boxes may be performed in a reverse sequence. This is determined by a related function. It should also be noted that, each box in a block diagram and/or a flowchart and a combination of boxes in the block diagram and/or the flowchart may be implemented by using a dedicated hardware-based system configured to perform a specified function or operation, or may be implemented by using a combination of dedicated hardware and a computer instruction.

The modules described in the embodiments of this application may be implemented in software or hardware. The described modules may also be provided in a processor.

In another aspect, the present disclosure further provides a non-transient computer-readable storage medium. The non-transient computer-readable storage medium may be included in the device described in the above embodiments, or may exist alone without being assembled into the device. The non-transient computer-readable storage medium carries one or more programs. When the one or more programs are executed by a device, the following steps of the method are implemented:

obtaining a first ordered dictionary tree and a second ordered dictionary tree, wherein the first ordered dictionary tree is created according to a hierarchical relationship of service data of a first object, and the second ordered dictionary tree is created according to a hierarchical relationship of service data of a second object; converting data of each of leaf nodes of the first ordered dictionary tree and the second ordered dictionary tree into binary data; and performing a comparison operation on the binary data of the leaf nodes at corresponding positions of the first ordered dictionary tree and the second ordered dictionary tree to obtain a difference between the service data of the first object and the second object.

In some embodiments, when the machine-executable instructions are executed by the processor, the following steps of the method are implemented: performing an exclusive OR operation on the binary data of the leaf nodes at corresponding positions of the first ordered dictionary tree and the second ordered dictionary tree to obtain a comparison result; and determining, in response to that the comparison result is not zero, that there is a difference between the service data of the first object and the second object at the corresponding positions.

In some embodiments, when the machine-executable instructions are executed by the processor, the following steps of the method are implemented: dividing the binary data of the leaf nodes at the corresponding positions of the first ordered dictionary tree and the second ordered dictionary tree into first parts and second parts; determining, in response to that a comparison result of a first part of the leaf node at the corresponding position of the first ordered dictionary tree and a first part of the leaf node at the corresponding position of the second ordered dictionary tree is not zero, that the first ordered dictionary tree or the second ordered dictionary tree lacks service data at the corresponding position; and determining, when a comparison result of a second part of the leaf node at the corresponding position of the first ordered dictionary tree and a second part of the leaf node at the corresponding position of the second ordered dictionary tree is not zero, that the first ordered dictionary tree or the second ordered dictionary tree has an error in service data at the corresponding position.

In some embodiments, each of the leaf nodes of the first ordered dictionary tree and the second ordered dictionary tree includes binary data of a partner identifier, a store identifier, a device identifier, a transaction record identifier, an amount, a day switch time, and a transaction status.

In some embodiments, a first part of the leaf node includes binary data of the partner identifier, the store identifier, the device identifier, and the transaction record identifier, and a second part of the leaf node includes binary data of the amount, the day switch time, and the transaction status.

In some embodiments, the data of the first ordered dictionary tree and the second ordered dictionary tree are arranged in ascending order of size from left to right.

In some embodiments, each of the leaf nodes of the first ordered dictionary tree and the second ordered dictionary tree includes data of a corresponding intermediate node.

In some embodiments, when the machine-executable instructions are executed by the processor, the following comparison operation is implemented: segmenting the binary data of the leaf nodes at the corresponding positions of the first ordered dictionary tree and the second ordered dictionary tree; and performing, in a distributed manner, comparison on the data obtained through the segmentation.

In some embodiments, when the machine-executable instructions are executed by the processor, the following steps of the method are further implemented: collecting differences between the service data of the first object and the second obj ect; and classifying the differences between the service data of the first object and the second object according to a collection result to generate a fishbone diagram.

FIG. 5 is a schematic structural diagram of an electronic device 400 adapted to implement the embodiments of this application. The electronic device shown in FIG. 5 is merely an example, and should not impose any limitation on a function and use scope of the embodiments of this application.

As shown in FIG. 5, the electronic device 400 includes a processor 401 that can perform various proper actions and processing according to a program stored in a storage medium 403. In particular, according to the embodiments of the present disclosure, the processes described above with reference to the flowchart may be implemented as a computer software program. For example, embodiments of the present disclosure include a computer program product, including a computer program carried on a computer-readable medium. The computer program includes program code for performing the method shown in the flowchart. When the computer program is executed by the processor 401, the above functions defined in the system of this application are performed. The processor 401, the storage medium 403, and a communication interface 402 are connected to each other through a bus.

Flowcharts and block diagrams in the accompanying drawings illustrate architectures, functions, and operations that may be implemented by using a terminal, a server, a method, and a computer program product according to the various embodiments of this application. In this regard, each block in the flowchart or the block diagram may represent a module, a program segment, or a part of code. The module, the program segment, or the part of the code includes one or more executable instructions for implementing a specified logical function. It should also be noted that, in some embodiments used as substitutes, functions annotated in boxes may alternatively be occur in a sequence different from that annotated in an accompanying drawing. For example, actually two boxes shown in succession may be performed basically in parallel, and sometimes the two boxes may be performed in a reverse sequence. This is determined by a related function. It should also be noted that, each box in a block diagram and/or a flowchart and a combination of boxes in the block diagram and/or the flowchart may be implemented by using a dedicated hardware-based system configured to perform a specified function or operation, or may be implemented by using a combination of dedicated hardware and a computer instruction.

The modules described in the embodiments of this application may be implemented in software or hardware. The described modules may also be provided in a processor.

In another aspect, the present disclosure further provides a non-transient computer-readable storage medium. The non-transient computer-readable storage medium may be included in the device described in the above embodiments, or may exist alone without being assembled into the device. The non-transient computer-readable storage medium carries one or more programs. When the one or more programs are executed by a device, the following steps are implemented:

obtaining a first ordered dictionary tree and a second ordered dictionary tree, wherein the first ordered dictionary tree is created according to a hierarchical relationship of service data of a first object, and the second ordered dictionary tree is created according to a hierarchical relationship of service data of a second object; converting data of each of leaf nodes of the first ordered dictionary tree and the second ordered dictionary tree into binary data; and performing a comparison operation on the binary data of the leaf nodes at corresponding positions of the first ordered dictionary tree and the second ordered dictionary tree to obtain a difference between the service data of the first object and the second object.

In some embodiments, the one or more programs, when executed by the device, implements the following steps of the method: performing an exclusive OR operation on the binary data of the leaf nodes at corresponding positions of the first ordered dictionary tree and the second ordered dictionary tree to obtain a comparison result; and determining, in response to that the comparison result is not zero, that there is a difference between the service data of the first object and the second object at the corresponding positions.

In some embodiments, the one or more programs, when executed by the device, implements the following steps of the method: dividing the binary data of the leaf nodes at the corresponding positions of the first ordered dictionary tree and the second ordered dictionary tree into first parts and second parts; determining, in response to that a comparison result of a first part of the leaf node at the corresponding position of the first ordered dictionary tree and a first part of the leaf node at the corresponding position of the second ordered dictionary tree is not zero, that the first ordered dictionary tree or the second ordered dictionary tree lacks service data at the corresponding position; and determining, when a comparison result of a second part of the leaf node at the corresponding position of the first ordered dictionary tree and a second part of the leaf node at the corresponding position of the second ordered dictionary tree is not zero, that the first ordered dictionary tree or the second ordered dictionary tree has an error in service data at the corresponding position.

In some embodiments, each of the leaf nodes of the first ordered dictionary tree and the second ordered dictionary tree includes binary data of a partner identifier, a store identifier, a device identifier, a transaction record identifier, an amount, a day switch time, and a transaction status.

In some embodiments, a first part of the leaf node includes binary data of the partner identifier, the store identifier, the device identifier, and the transaction record identifier, and a second part of the leaf node includes binary data of the amount, the day switch time, and the transaction status.

In some embodiments, the data of the first ordered dictionary tree and the second ordered dictionary tree are arranged in ascending order of size from left to right.

In some embodiments, each of the leaf nodes of the first ordered dictionary tree and the second ordered dictionary tree includes data of a corresponding intermediate node.

In some embodiments, the one or more programs, when executed by the device, implements the following comparison operation is implemented: segmenting the binary data of the leaf nodes at the corresponding positions of the first ordered dictionary tree and the second ordered dictionary tree; and performing, in a distributed manner, comparison on the data obtained through the segmentation.

In some embodiments, the one or more programs, when executed by the device, implements the following steps of the method, implements the following steps of the method are further implemented: collecting differences between the service data of the first object and the second object; and classifying the differences between the service data of the first object and the second object according to a collection result to generate a fishbone diagram.

The present disclosure discloses a service data processing method, a service data processing apparatus, an electronic device, and a computer-readable medium. Other features and advantages of the present disclosure will be apparent through the following detailed description, or partly learned through practice of the present disclosure.

According to an aspect of the present disclosure, a service data processing method is provided, including: obtaining a first ordered dictionary tree and a second ordered dictionary tree, where the first ordered dictionary tree is created according to a hierarchical relationship of service data of a first object, and the second ordered dictionary tree is created according to a hierarchical relationship of service data of a second object; converting data of each of leaf nodes of the first ordered dictionary tree and the second ordered dictionary tree into binary data; and performing a comparison operation on the binary data of the leaf nodes at corresponding positions of the first ordered dictionary tree and the second ordered dictionary tree to obtain a difference between the service data of the first object and the second object.

In some embodiments, the performing a comparison operation on the binary data of the leaf nodes at corresponding positions of the first ordered dictionary tree and the second ordered dictionary tree includes: performing an exclusive OR operation on the binary data of the leaf nodes at corresponding positions of the first ordered dictionary tree and the second ordered dictionary tree to obtain a comparison result; and determining, in response to that the comparison result is not zero, that there is a difference between the service data of the first object and the second object at the corresponding positions.

In some embodiments, the determining, in response to that the comparison result is not zero, that there is a difference between the service data of the first object and the second object at the corresponding positions includes: dividing the binary data of the leaf nodes at the corresponding positions of the first ordered dictionary tree and the second ordered dictionary tree into first parts and second parts; determining, in response to that a comparison result of a first part of the leaf node at the corresponding position of the first ordered dictionary tree and a first part of the leaf node at the corresponding position of the second ordered dictionary tree is not zero, that the first ordered dictionary tree or the second ordered dictionary tree lacks service data at the corresponding position; and determining, when a comparison result of a second part of the leaf node at the corresponding position of the first ordered dictionary tree and a second part of the leaf node at the corresponding position of the second ordered dictionary tree is not zero, that the first ordered dictionary tree or the second ordered dictionary tree has an error in service data at the corresponding position.

In some embodiments, each of the leaf nodes of the first ordered dictionary tree and the second ordered dictionary tree includes binary data of a partner identifier, a store identifier, a device identifier, a transaction record identifier, an amount, a day switch time, and a transaction status.

In some embodiments, a first part of the leaf node includes binary data of the partner identifier, the store identifier, the device identifier, and the transaction record identifier, and a second part of the leaf node includes binary data of the amount, the day switch time, and the transaction status.

In some embodiments, the data on each layer of the first ordered dictionary tree and the second ordered dictionary tree are arranged in ascending order of size from left to right.

In some embodiments, each of the leaf nodes of the first ordered dictionary tree and the second ordered dictionary tree includes data of a corresponding intermediate node.

In some embodiments, the comparison operation includes: segmenting the binary data of the leaf nodes at the corresponding positions of the first ordered dictionary tree and the second ordered dictionary tree; and performing, in a distributed manner, comparison on the data obtained through the segmentation.

In some embodiments, the method further includes: collecting differences between the service data of the first obj ect and the second object; and classifying the differences between the service data of the first object and the second object according to a collection result to generate a fishbone diagram.

According to an aspect of the present disclosure, a service data processing apparatus is provided, including: a dictionary tree obtaining module configured to obtain a first ordered dictionary tree and a second ordered dictionary tree, where the first ordered dictionary tree is created according to a hierarchical relationship of service data of a first object, and the second ordered dictionary tree is created according to a hierarchical relationship of service data of a second obj ect; a data format conversion module, configured to convert data of each of leaf nodes of the first ordered dictionary tree and the second ordered dictionary tree into binary data; and a data comparison module, configured to perform a comparison operation on the binary data of the leaf nodes at corresponding positions of the first ordered dictionary tree and the second ordered dictionary tree to obtain a difference between the service data of the first object and the second object.

According to an aspect of the present disclosure, an electronic device is provided, including a storage medium, a processor, and machine executable instruction stored on the storage medium and executable on the processor, the machine executable instruction implementing steps of the method according to any of the foregoing embodiments when being executed by the processor.

According to an aspect of the present disclosure, a computer readable medium is provided, a computer program being stored thereon, where when the program is executed by a processor, steps of the method according to any of the foregoing embodiments are implemented.

For the service data processing method and apparatus, the electronic device, and the computer readable medium according to some embodiments of the present disclosure, the ordered dictionary trees are created for service data of different objects, respectively, and the data of each of the leaf nodes of the ordered dictionary trees is converted into binary data for storage, and then the binary data is used for comparison, to obtain the difference between the service data of different objects. By transforming the service data into the ordered dictionary trees and converting the leaf nodes of the ordered dictionary trees into binary numbers for comparison, a speed at which comparison of differences between the service data is performed can be effectively improved, thereby meeting real-time and accuracy requirements of the service data processing.

Some embodiments of the present disclosure have been shown and described above. It should be understood that the present disclosure is not limited to the detailed structures, configurations or implementation methods described herein. On the contrary, the present disclosure is intended to cover various modifications and equivalent configurations within the spirit and scope of the appended claims.

1. A service data processing method, comprising:
obtaining a first ordered dictionary tree and a second ordered dictionary tree, wherein the first ordered dictionary tree is created according to a hierarchical relationship of service data of a first object, and the second ordered dictionary tree is created according to a hierarchical relationship of service data of a second object;
converting data of each of leaf nodes of the first ordered dictionary tree and the second ordered dictionary tree into binary data; and
performing a comparison operation on the binary data of the leaf nodes at corresponding positions of the first ordered dictionary tree and the second ordered dictionary tree to obtain a difference between the service data of the first object and the second object.

2. The method according to claim 1, wherein the performing a comparison operation on the binary data of the leaf nodes at corresponding positions of the first ordered dictionary tree and the second ordered dictionary tree comprises:
performing an exclusive OR operation on the binary data of the leaf nodes at the corresponding positions of the first ordered dictionary tree and the second ordered dictionary tree to obtain a comparison result; and
determining, in response to that the comparison result is not zero, that there is a difference between the service data of the first object and the second object at the corresponding positions.

3. The method according to claim 2, wherein the determining that there is a difference between the service data of the first object and the second object at the corresponding positions comprises:
dividing the binary data of the leaf nodes at the corresponding positions of the first ordered dictionary tree and the second ordered dictionary tree into first parts and second parts;
determining, in response to that a comparison result of the first part of the leaf node at the corresponding position of the first ordered dictionary tree and the first part of the leaf node at the corresponding position of the second ordered dictionary tree is not zero, that the first ordered dictionary tree or the second ordered dictionary tree lacks service data at the corresponding position; and
determining, in response to that a comparison result of the second part of the leaf node at the corresponding position of the first ordered dictionary tree and the second part of the leaf node at the corresponding position of the second ordered dictionary tree is not zero, that the first ordered dictionary tree or the second ordered dictionary tree has erroneous service data at the corresponding position.

4. The method according to claim 3, wherein each of the leaf nodes of the first ordered dictionary tree and the second ordered dictionary tree comprises binary data of a partner identifier, a store identifier, a device identifier, a transaction record identifier, an amount, a day switch time, and a transaction status.

5. The method according to claim 4, wherein
the first part of the leaf node comprises the binary data of the partner identifier, the store identifier, the device identifier, and the transaction record identifier, and
the second part of the leaf node comprises the binary data of the amount, the day switch time, and the transaction status.

6. The method according to claim 1, wherein the data of the first ordered dictionary tree and the second ordered dictionary tree are arranged in ascending order of size from left to right.

7. The method according to claim 1, wherein each of the leaf nodes of the first ordered dictionary tree and the second ordered dictionary tree comprises data of a corresponding intermediate hierarchical node.

8. The method according to claim 1, wherein the comparison operation comprises:
segmenting the binary data of the leaf nodes at the corresponding positions of the first ordered dictionary tree and the second ordered dictionary tree; and
performing, in a distributed manner, comparison on the data obtained through the segmentation.

9. The method according to claim 1, further comprising:
collecting differences between the service data of the first object and the second object; and
classifying the differences between the service data of the first object and the second object according to a collection result to generate a fishbone diagram.

10. (canceled)

11. An electronic device, comprising a storage medium, a processor, and machine-executable instructions stored on the storage medium and runnable on the processor, wherein when the machine-executable instructions are executed by the processor, the following steps are implemented:
obtaining a first ordered dictionary tree and a second ordered dictionary tree, wherein the first ordered dictionary tree is created according to a hierarchical relationship of service data of a first object, and the second ordered dictionary tree is created according to a hierarchical relationship of service data of a second object;
converting data of each of leaf nodes of the first ordered dictionary tree and the second ordered dictionary tree into binary data; and
performing a comparison operation on the binary data of the leaf nodes at corresponding positions of the first ordered dictionary tree and the second ordered dictionary tree to obtain a difference between the service data of the first obiect and the second obiect.

12. A non-transient computer readable storage medium storing a computer program thereon, wherein when the program is executed by a processor, steps of the method according to claim 1 are implemented.

13. The electronic device according to claim 11, wherein when the machine-executable instructions are executed by the processor, the following steps are implemented:
performing an exclusive OR operation on the binary data of the leaf nodes at the corresponding positions of the first ordered dictionary tree and the second ordered dictionary tree to obtain a comparison result; and
determining, in response to that the comparison result is not zero, that there is a difference between the service data of the first object and the second object at the corresponding positions.

14. The electronic device according to claim 13, wherein when the machine-executable instructions are executed by the processor, the following steps are implemented:
dividing the binary data of the leaf nodes at the corresponding positions of the first ordered dictionary tree and the second ordered dictionary tree into first parts and second parts;
determining, in response to that a comparison result of the first part of the leaf node at the corresponding position of the first ordered dictionary tree and the first part of the leaf node at the corresponding position of the second ordered dictionary tree is not zero, that the first ordered dictionary tree or the second ordered dictionary tree lacks service data at the corresponding position; and
determining, in response to that a comparison result of the second part of the leaf node at the corresponding position of the first ordered dictionary tree and the second part of the leaf node at the corresponding position of the second ordered dictionary tree is not zero, that the first ordered dictionary tree or the second ordered dictionary tree has an error in service data at the corresponding position.

15. The electronic device according to claim 14, wherein each of the leaf nodes of the first ordered dictionary tree and the second ordered dictionary tree comprises binary data of a partner identifier, a store identifier, a device identifier, a transaction record identifier, an amount, a day switch time, and a transaction status.

16. The electronic device according to claim 15, wherein
the first part of the leaf node comprises the binary data of the partner identifier, the store identifier, the device identifier, and the transaction record identifier, and
the second part of the leaf node comprises the binary data of the amount, the day switch time, and the transaction status.

17. The electronic device according to claim 11, wherein the data of the first ordered dictionary tree and the second ordered dictionary tree are arranged in ascending order of size from left to right.

18. The electronic device according to claim 11, wherein each of the leaf nodes of the first ordered dictionary tree and the second ordered dictionary tree comprises data of a corresponding intermediate node.

19. The electronic device according to claim 11, wherein when the machine-executable instructions are executed by the processor, the following comparison operation is implemented:
segmenting the binary data of the leaf nodes at the corresponding positions of the first ordered dictionary tree and the second ordered dictionary tree; and
performing, in a distributed manner, comparison on the data obtained through the segmentation.

20. The electronic device according to claim 11, wherein when the machine-executable instructions are executed by the processor, the following steps are implemented:
collecting differences between the service data of the first object and the second object; and
classifying the differences between the service data of the first object and the second object according to a collection result to generate a fishbone diagram.
